(19) United States
(12) Patent Application Publication
(10) Pub. No.: US 2010/0005140 A1
(43) Pub. Date: Jan. 7, 2010

(54) ELECTRONIC DEVICES AND METHOD FOR SHARING PRODUCT-RELATED DATA

(75) Inventors: Wenying You, Shanghai (CN); Gongming Wei, Shanghai (CN); Darwin He, Shanghai (CN); Steven Broelis Luitjens, Eindhoven (NL); Feng Li, Shanghai (CN); Wilhelmus Franciscus Johannes Fontijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,195

(22) PCT Filed: Dec. 19, 2005
(86) PCT No.: PCT/IB05/54311

§ 371 Date: Jun. 20, 2007

(30) Foreign Application Priority Data
Dec. 28, 2004 (EP) 04107014.5

(51) Int. Cl. G06F 15/16

(52) U.S. Cl. 709/204

(57) ABSTRACT

The electronic device (21) for receiving product-related data comprises a memory (23) for storing a unique product identifier identifying a product selected from a database, a wireless transmitter (25), a wireless receiver (27) and a processor (29). The processor (29) performs a method comprising the steps of wirelessly transmitting a unique product identifier to be received by a nearby electronic device, the unique product identifier identifying a product selected from a database, and wirelessly receiving data related to said product from the nearby electronic device. The electronic device (31) for transmitting product-related data comprises a storage means (33) for storing a unique product identifier and data associated with the unique product identifier, a wireless transmitter (35), a wireless receiver (37) and a processor (39). The processor performs a method comprising the steps of wirelessly receiving a unique product identifier from a further electronic device in a vicinity of the electronic device, the unique product identifier identifying a product selected from a database, and wirelessly transmitting data associated with the unique product identifier to the further electronic device.

The invention relates to an electronic device, in particular a portable electronic device, for receiving product-related data.

The invention further relates to an electronic device, a further portable electronic device or a wireless access point, for example, for transmitting product-related data.

The invention also relates to a method of receiving product-related data.

The invention further relates to software for making a programmable device operative to perform a method of receiving product-related data.

The invention also relates to a method of transmitting product-related data.

The invention further relates to software for making a programmable device operative to perform a method of transmitting product-related data.

The invention also relates to a method of enabling an electronic device to receive product-related data.

The invention further relates to a method of enabling an electronic device to transmit product-related data.

An example of a method of receiving product-related data and a corresponding method of transmitting data related to the product is described in US 2002/0144007. In the system described in US 2002/0144007, a portable electronic device contains a user profile which consists of keywords. When the portable electronic device approaches a beacon, the beacon will transmit a list of services that are offered in the vicinity of the beacon to the portable electronic device. The portable electronic device compares the user profile with the service description and warns the user if they match. Unfortunately, this matching operation is complex and error-prone. A keyword may be too broad, leading to many unnecessary warnings, or may be too specific, in which case too few warnings will be generated.

It is a first object of the invention to provide electronic devices of the type described in the opening paragraph, which enable a user to more easily find desired products.

According to the invention, the first object is realized in that the electronic device for receiving product-related data comprises a memory for storing a unique product identifier identifying a product selected from a database, a wireless transmitter operative to transmit wireless signals, a wireless receiver operative to receive wireless signals, and a processor operative to retrieve the unique product identifier from the memory, instruct the wireless transmitter to transmit the unique product identifier to be received by a further electronic device in a vicinity of the electronic device, and use the wireless receiver to receive product-related data from the further electronic device. The amount of unnecessary and missed warnings is thereby reduced, as the user selects a specific product in advance from a database and only receives data related to this specific product.

The electronic device for receiving product-related data may be, for example, a mobile phone, a PDA, or a mobile entertainment device. The product may be, for example, a physical object, a software product, electronic content, a game or a service. The product identifier is unique among a group of persons who share data with each other, e.g. a group of friends or a global community. A user may be able to select the product from, for example, a database through the Internet, a locally stored copy of a database distributed on the Internet or a locally compiled database of locally stored products. In the latter case, the locally stored products, e.g. games, need to be distributed with a unique product identifier. In a first scenario, a user physically walks through a shopping mall and receives a notification on his portable electronic device when a specific desired product, e.g. a physical object or a service, is available in a store in his vicinity. In a second scenario, the user has several games installed on his portable gaming device and indicates which ones he wants to play. As soon as another user approaches who has also indicated that he wants to play at least one of these games, one or both users receive a notification.

According to the invention, the first object is realized in that the electronic device for transmitting product-related data comprises a storage means for storing a unique product identifier and data associated with the unique product identifier, a wireless transmitter operative to transmit wireless signals, a wireless receiver operative to receive wireless signals, and a processor operative to use the wireless receiver to receive the unique product identifier from a further electronic device in a vicinity of the electronic device, retrieve the data associated with the unique product identifier from the storage means, and instruct the wireless transmitter to transmit the data associated with the unique product identifier to the further electronic device. The electronic device may be, for example, a portable electronic device of a user who is willing to share data, or an electronic beacon located in a shopping area. The concept of electronic beacons is described in US2002/144007 and U.S. Pat. No. 6,782,253. Both documents are herein incorporated by reference. A software tool may be available to automatically associate product-related data, e.g. software products and electronic content, with a product identifier. Alternatively, a user wanting to share product-related data may have to manually associate the data with a product selected from a database.

Said product may comprise at least one of software and electronic content and the processor of the electronic device for receiving product-related data may be capable of using the wireless receiver to receive the at least one of software and electronic content from the further electronic device. In this case, said product-related data comprises the product's software and/or the product's content. In a third scenario, the user walks through a crowded area and electronic content he is looking for is automatically downloaded when he is in the vicinity of another user who has made the desired content available. This allows the user to obtain new software and electronic content with very little effort.

Said product-related data may comprise a photograph of a person or a building. This allows a user of the electronic device for receiving product-related data to quickly identify where he can obtain the desired product. This is especially convenient when the user wants to obtain physical products or when two users are not yet close enough to each other to transfer a software product or electronic content as quickly as desired.

Said product-related data may comprise position information. As an alternative or complement to a photograph, position information also allows a user of the electronic device for receiving product-related data to quickly identify where he can obtain the desired product. The position information may comprise, for example, a map on which a building or a person is indicated, a route description to a building or a person, or a building or a person's coordinates.

The processor of the electronic device for receiving product-related data may further be operative to generate a human perceptual signal when at least part of said product-related data has been received. Although product-related data may be stored for later reproduction, a human perceptual signal, e.g. an audible signal, attracts the user's attention, thereby allowing him, for example, to buy the product on his current visit to the shopping mall.

It is a second object of the invention to provide methods of the kind described in the opening paragraph, which enable a user to more easily find desired products.

According to the invention, the second object is realized in that the method of receiving data comprises the steps of wirelessly transmitting a unique product identifier to be received by a nearby electronic device, the unique product identifier identifying a product selected from a database, and wirelessly receiving product-related data from the nearby electronic device.

According to the invention, the second object is realized in that the method of transmitting data comprises the steps of wirelessly receiving a unique product identifier from a further electronic device in a vicinity of the electronic device, the unique product identifier identifying a product selected from a database, and wirelessly transmitting data associated with the unique product identifier to the further electronic device.

The method may be performed by a real or virtual electronic device. In a fourth scenario, the user navigates an avatar through a virtual shopping mall in a virtual reality environment and receives a notification when a specific desired product is available in a virtual store in the vicinity of the avatar using virtual wireless technology. Furthermore, U.S. Pat. No. 6,025,801, herein incorporated by reference, describes a method of transmitting virtual environment data, in which the data transmitted to a user depends on the distance between him and one or more other users in the virtual environment. In an embodiment of the method, as soon as a user receives virtual environment data which includes an avatar of another user, the virtual electronic device of the user's avatar starts to transmit a unique product identifier to the virtual electronic device of the other user's avatar. The virtual electronic devices of the avatars and the virtual wireless transmission between the virtual electronic devices do not need to be represented in the graphical representation of the virtual environment.

These and other aspects of the devices and methods of the invention will be further elucidated and described with reference to the drawings, in which:

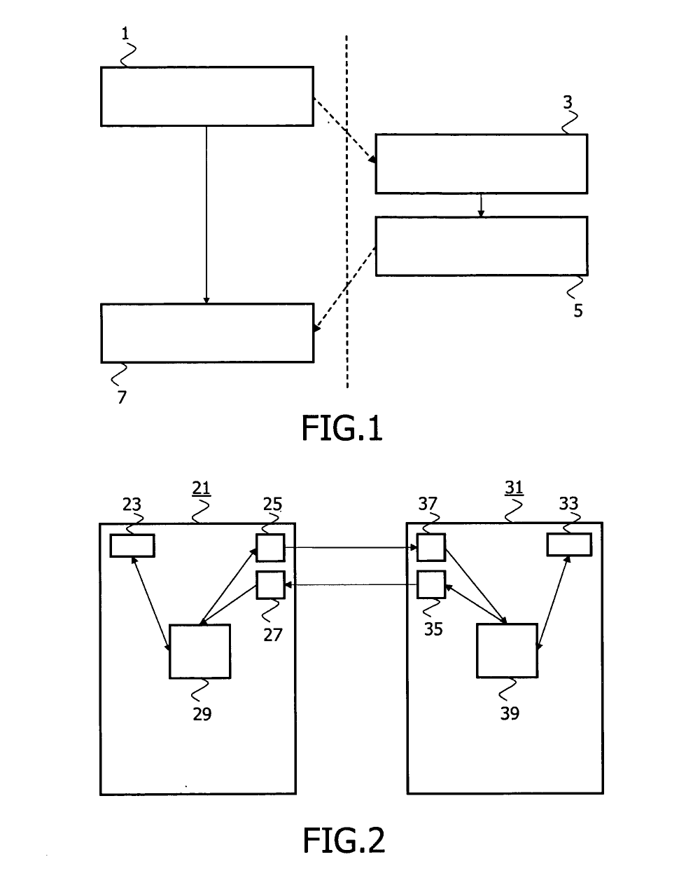

FIG. 1 is a flow diagram of the methods of the invention; and

FIG. 2 is a block diagram of the electronic devices of the invention.

The method of receiving product-related data comprises a step 1 and a step 7, see FIG. 1. The method of transmitting product-related data of the invention comprises a step 3 and a step 5, see also FIG. 1. First, an electronic device performs step 1 of wirelessly transmitting a unique product identifier to be received by a nearby electronic device. The unique product identifier identifies a product selected from a database. Step 1 results in the nearby electronic device performing step 3 of wirelessly receiving the unique product identifier from the electronic device. Subsequently, the nearby electronic device performs step 5 of wirelessly transmitting data associated with the unique product identifier to the electronic device. Step 5 results in the electronic device performing step 7 of wirelessly receiving said product-related data from the nearby electronic device. The methods may be implemented in software and/or in hardware.

If said product is a software product, said data transferred in steps 5 and 7 may be the product's software. If said product is electronic content, e.g. music or video, said data transferred in steps 5 and 7 may be the product's content.

Said product-related data may comprise a photograph of a person or a building and/or position information.

A further step of the method of receiving product-related data may comprise generating a human perceptual signal when at least part of said product-related data has been received.

FIG. 2 shows an electronic device 21 for receiving product-related data and an electronic device 31 for transmitting product-related data. The electronic device 21 comprises a memory 23 for storing a unique product identifier identifying a product selected from a database, a wireless transmitter 25 operative to transmit wireless signals, a wireless receiver 27 operative to receive wireless signals, and a processor 29. The processor 29 is operative to retrieve the unique product identifier from the memory 23, instruct the wireless transmitter 25 to transmit the unique product identifier to be received by the electronic device 31 in a vicinity of the electronic device 21, and use the wireless receiver 27 to receive product-related data from the electronic device 31.

The electronic device 31 comprises a storage means 33 for storing a unique product identifier and data associated with the unique product identifier, a wireless transmitter 35 operative to transmit wireless signals, a wireless receiver 37 operative to receive wireless signals, and a processor 39. The processor 39 is operative to use the wireless receiver 37 to receive the unique product identifier from the electronic device 21 in a vicinity of the electronic device 31, retrieve the data associated with the unique product identifier from the storage means 33, and instruct the wireless transmitter 35 to transmit the data associated with the unique product identifier to the electronic device 21.

The wireless receivers 27 and 37 and the wireless transmitters 29 and 39 may use Bluetooth, Wireless LAN, Near Field Communication (NFC) or another wireless technology. Memory 23 and storage means 33 may be flash memory, magnetic memory, hard disc memory, optical disc memory or another type of storage means. The electronic device 21 may be a portable electronic device, such as, for example, a mobile phone, a PDA or a mobile entertainment device. The electronic device 31 may be, for example, a portable electronic device or a wireless access point, i.e. a beacon. The processors 29 and 39 may be any suitable processor, general-purpose or application-specific processor. The electronic device 21 and/or the electronic device 31 may be connected to the Internet, e.g. through a 3 G/UMTS or 4 G connection. The database may be, for example, a locally stored database or a database on the Internet, e.g. accessible through a web site.

While the invention has been described in connection with preferred embodiments, it will be understood that modifications thereof within the principles outlined above will be evident to those skilled in the art, and thus the invention is not limited to the preferred embodiments but is intended to encompass such modifications. The invention resides in each and every novel characteristic feature and each and every combination of characteristic features. Reference numerals in the claims do not limit their protective scope. Use of the verb “to comprise” and its conjugations does not exclude the presence of elements or steps other than those stated in the claims. Use of the article “a” or “an” preceding an element or step does not exclude the presence of a plurality of such elements or steps.

‘Means’, as will be apparent to a person skilled in the art, are meant to include any hardware (such as separate or integrated circuits or electronic elements) or software (such as programs or parts of programs) which perform in operation or are designed to perform a specified function, be it solely or in conjunction with other functions, be it in isolation or in co-operation with other elements. The invention can be implemented by means of hardware comprising several distinct elements, and by means of a suitably programmed computer. In the device claims enumerating several means, several of these means can be embodied by one and the same item of hardware. ‘Software’ is to be understood to mean any software product stored on a computer-readable medium, such as a floppy disk, downloadable via a network, such as the Internet, or marketable in any other manner.

1. An electronic device (21) for receiving product-related data, comprising:
a memory (23) for storing a unique product identifier identifying a product selected from a database;
a wireless transmitter (25) operative to transmit wireless signals;
a wireless receiver (27) operative to receive wireless signals; and
a processor (29) operative to retrieve the unique product identifier from the memory (23), instruct the wireless transmitter (25) to transmit the unique product identifier to be received by a further electronic device (31) in a vicinity of the electronic device (21), and use the wireless receiver (27) to receive product-related data from the further electronic device (31).

2. An electronic device as claimed in claim 1, wherein said product comprises at least one of software and electronic content and the processor is operative to use the wireless receiver to receive the at least one of software and electronic content from the further electronic device.

3. An electronic device as claimed in claim 1, wherein said product-related data comprises a photograph of a building or a person.

4. An electronic device as claimed in claim 1, wherein said product-related data comprises position information.

5. An electronic device as claimed in claim 1, wherein the processor is further operative to generate a human perceptual signal when at least part of said product-related data has been received.

6. An electronic device (31) for transmitting product-related data, comprising:
a storage means (33) for storing a unique product identifier and data associated with the unique product identifier;
a wireless transmitter (35) operative to transmit wireless signals;
a wireless receiver (37) operative to receive wireless signals; and
a processor (39) operative to use the wireless receiver (37) to receive the unique product identifier from a further electronic device (21) in a vicinity of the electronic device (31), retrieve the data associated with the unique product identifier from the storage means (33), and instruct the wireless transmitter (35) to transmit the data associated with the unique product identifier to the further electronic device (21).

7. A method of receiving product-related data, comprising the steps of:
wirelessly transmitting (1) a unique product identifier to be received by a nearby electronic device, the unique product identifier identifying a product selected from a database; and
wirelessly receiving (7) product-related data from the nearby electronic device.

8. Software for making a programmable device operative to perform the method of claim 7.

9. A method of transmitting product-related data, comprising the steps of:
wirelessly receiving (3) a unique product identifier from a further electronic device in a vicinity of the electronic device, the unique product identifier identifying a product selected from a database; and
wirelessly transmitting (5) data associated with the unique product identifier to the further electronic device.

10. Software for making a programmable device operative to perform the method of claim 9.

11. A method of enabling an electronic device to receive product-related data, comprising the steps of:
enabling the electronic device to wirelessly transmit a unique product identifier to be received by a further electronic device in a vicinity of the electronic device, the unique product identifier identifying a product selected from a database; and
enabling the electronic device to wirelessly receive product-related data from the further electronic device.

12. A method of enabling an electronic device to transmit product-related data, comprising the steps of:
enabling the electronic device to wirelessly receive a unique product identifier from a further electronic device in a vicinity of the electronic device, the unique product identifier identifying a product selected from a database; and
enabling the electronic device to wirelessly transmit data associated with the unique product identifier to the further electronic device.
